(19) United States
(12) Patent Application Publication
(10) Pub. No.: US 2025/0284964 A1
(43) Pub. Date: Sep. 11, 2025

(54) CHATBOTS FOR ONBOARDING PROCESSES

(71) Applicant: Capital One Services, LLC, McLean, VA (US)

(72) Inventors: Mohamed SECK, Aubrey, TX (US); Shanice BRODIE, Silver Spring, MD (US)

(21) Appl. No.: 18/598,304

(22) Filed: Mar. 7, 2024

(51) Int. Cl. G06N 3/0895

(52) U.S. Cl. CPC G06N 3/0895

(57) ABSTRACT

In some implementations, a user device may transmit, to an onboarding system, a first inquiry. The user device may receive a first response, from the onboarding system and in response to the first inquiry. The first response may have been determined by a machine learning model. The user device may transmit, to the onboarding system, a second inquiry. The user device may receive, from the onboarding system, an indication of an escalation contact in response to the second inquiry. The user device may transmit, to the onboarding system, feedback associated with the first response. The user device may receive, from the onboarding system, an indication that the machine learning model has been updated based on the feedback.

### BACKGROUND

For years, many companies have provided customer service through chatbots. For example, a Capital One® customer may submit inquiries to Eno® and receive automated responses to those inquiries. With the rise of ChatGPT and other large language models, use of chatbots is on the rise.

### SUMMARY

Some implementations described herein relate to a system for providing a chatbot for an onboarding process. The system may include one or more memories and one or more processors communicatively coupled to the one or more memories. The one or more processors may be configured to receive, from a user device, a first inquiry. The one or more processors may be configured to provide the first inquiry to a machine learning model in order to receive a first response. The one or more processors may be configured to transmit the first response to the user device in response to the first inquiry. The one or more processors may be configured to receive, from the user device, a second inquiry. The one or more processors may be configured to provide the second inquiry to the machine learning model in order to receive an identifier of an escalation contact. The one or more processors may be configured to transmit, in response to the second inquiry, an indication of the escalation contact. The one or more processors may be configured to receive feedback associated with the first response. The one or more processors may be configured to determine at least one feature, associated with the machine learning model, to eliminate based on the feedback. The one or more processors may be configured to transmit a command to update the machine learning model by removing the at least one feature.

Some implementations described herein relate to a method of using a chatbot for an onboarding process. The method may include transmitting, from a user device and to an onboarding system, a first inquiry. The method may include receiving a first response, from the onboarding system and at the user device, in response to the first inquiry, wherein the first response was determined by a machine learning model. The method may include transmitting, from the user device and to the onboarding system, a second inquiry. The method may include receiving, from the onboarding system and at the user device, an indication of an escalation contact in response to the second inquiry. The method may include transmitting, from the user device and to the onboarding system, feedback associated with the first response. The method may include receiving, from the onboarding system and at the user device, an indication that the machine learning model has been updated based on the feedback.

Some implementations described herein relate to a non-transitory computer-readable medium that stores a set of instructions for providing a chatbot for an onboarding process. The set of instructions, when executed by one or more processors of a device, may cause the device to receive, from a user device, a first inquiry. The set of instructions, when executed by one or more processors of the device, may cause the device to provide the first inquiry to a machine learning model in order to receive a first response. The set of instructions, when executed by one or more processors of the device, may cause the device to transmit the first response to the user device in response to the first inquiry. The set of instructions, when executed by one or more processors of the device, may cause the device to receive, from the user device, a second inquiry. The set of instructions, when executed by one or more processors of the device, may cause the device to determine an escalation contact, selected from a plurality of possible escalation contacts, based on content of the second inquiry. The set of instructions, when executed by one or more processors of the device, may cause the device to transmit, in response to the second inquiry, an indication of the escalation contact. The set of instructions, when executed by one or more processors of the device, may cause the device to detect a sentiment associated with input from the user device. The set of instructions, when executed by one or more processors of the device, may cause the device to determine at least one feature, associated with the machine learning model, to eliminate based on the sentiment. The set of instructions, when executed by one or more processors of the device, may cause the device to transmit a command to update the machine learning model by removing the at least one feature.

### BRIEF DESCRIPTION OF THE DRAWINGS

FIGS. 1A-1F are diagrams of an example implementation relating to a chatbot for an onboarding process, in accordance with some embodiments of the present disclosure.

FIG. 2 is a diagram illustrating an example of training and using a machine learning model in connection with systems and/or methods described herein, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to providing a chatbot for an onboarding process, in accordance with some embodiments of the present disclosure.

FIG. 6 is a flowchart of an example process relating to using a chatbot for an onboarding process, in accordance with some embodiments of the present disclosure.

### DETAILED DESCRIPTION

The following detailed description of example implementations refers to the accompanying drawings. The same reference numbers in different drawings may identify the same or similar elements.

Chatbots can provide customer service and otherwise respond to questions from customers. For example, a chatbot may detect keywords in questions and use the keywords to select a response out of a set of possible responses. When the chatbot is unable to map keywords in a question to a response in the set of possible responses, the chatbot may provide generic contact information to a customer (e.g., a telephone number for a customer service department and/or a form to complete to send an email message to the customer service department, among other examples). However, such escalations are untargeted. For example, the customer may provide the same information to the customer service department as was provided to the chatbot, which wastes power and processing resources at a user device of the customer and at an administrator device of the customer service department. Additionally, the customer may be redirected to different experts in the customer service department, which further wastes power and processing resources.

Additionally, if a chatbot is deployed to help onboard an employee, the chatbot may become bloated if trained on an extensive amount of data (e.g., employee rules and/or software documentation, among other examples). As a result, the chatbot may consume additional power and processing resources in responding to queries from the employee. Furthermore, longer responses from the chatbot may result in more escalations from the employee, which further wastes power and processing resources.

Some implementations described herein enable a machine learning model for a chatbot to perform feature elimination. As a result, the machine learning model has less overhead and bloat, which conserves power and processing resources each time the machine learning model responds to an inquiry. Additionally, or alternatively, some implementations described herein enable a machine learning model for a chatbot to perform targeted escalation. For example, the machine learning model may identify a particular administrator to contact based on subject matter of an inquiry from a user. As a result, power and processing resources are conserved because the user is not redirected to different experts from a generic escalation contact.

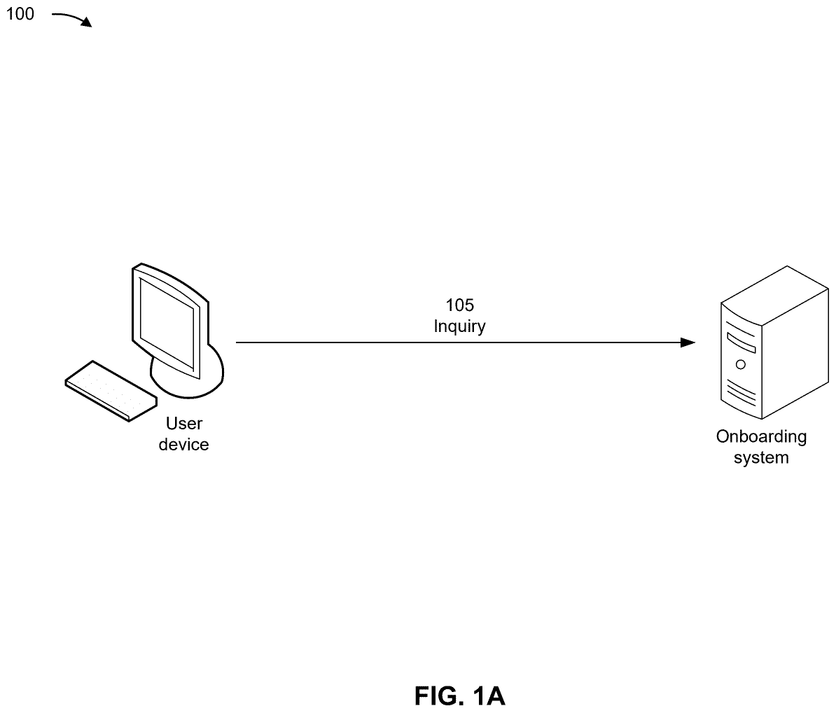

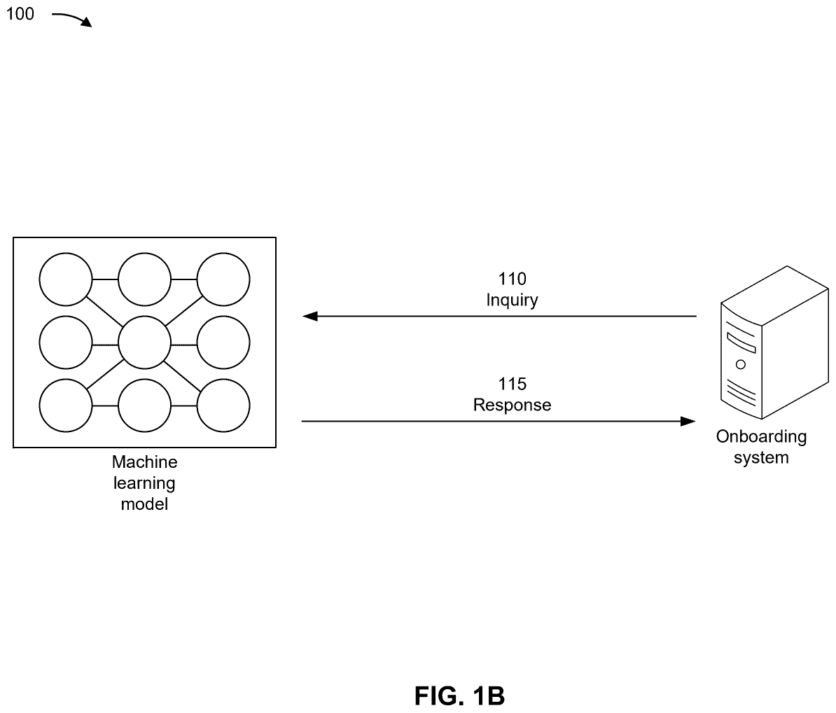

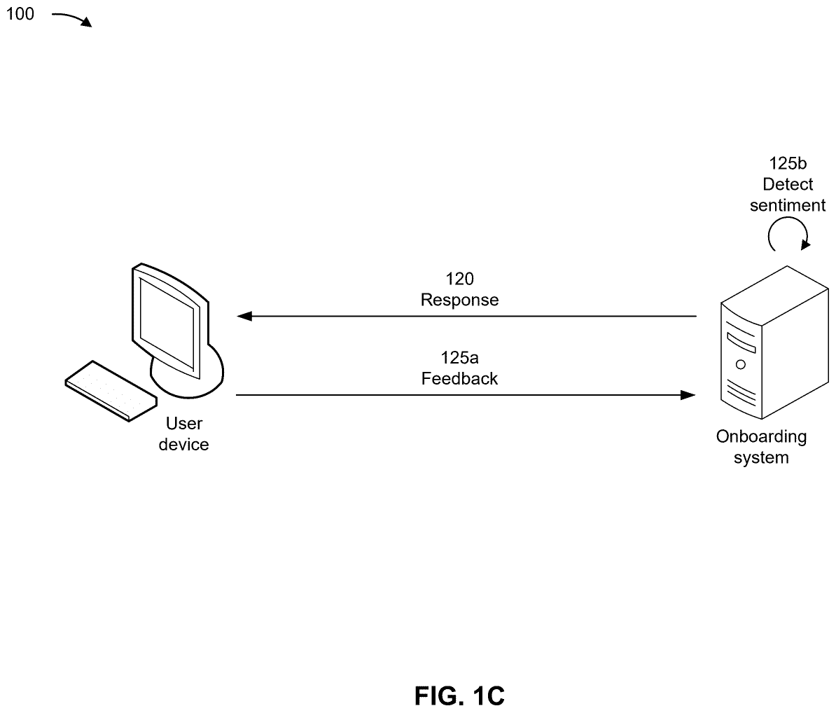

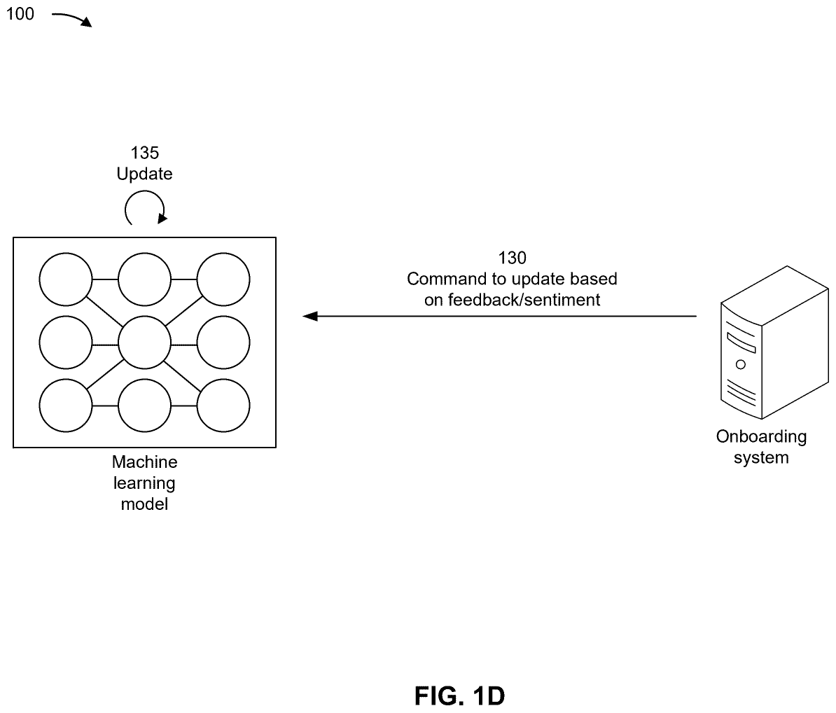

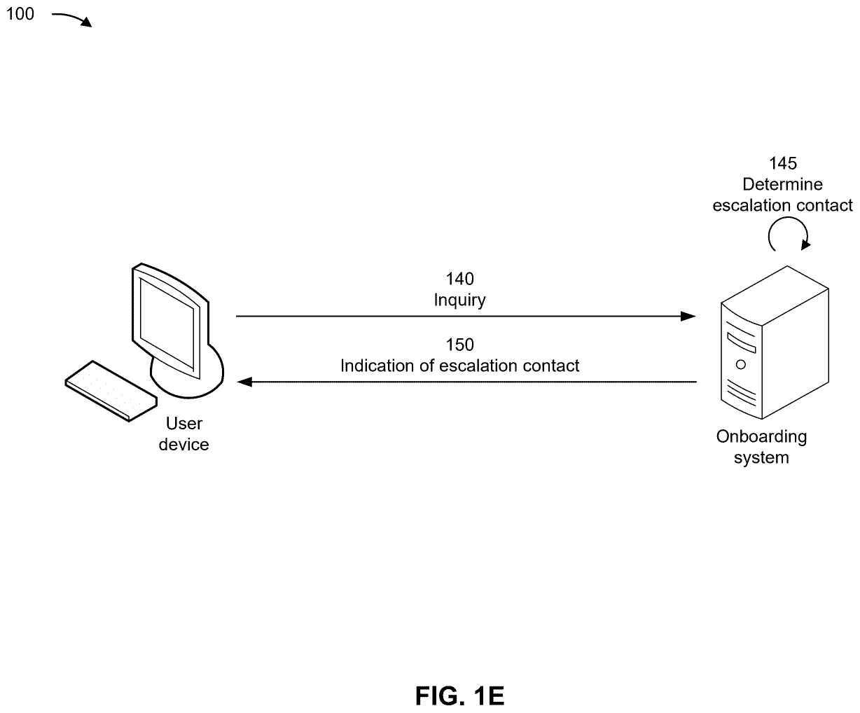

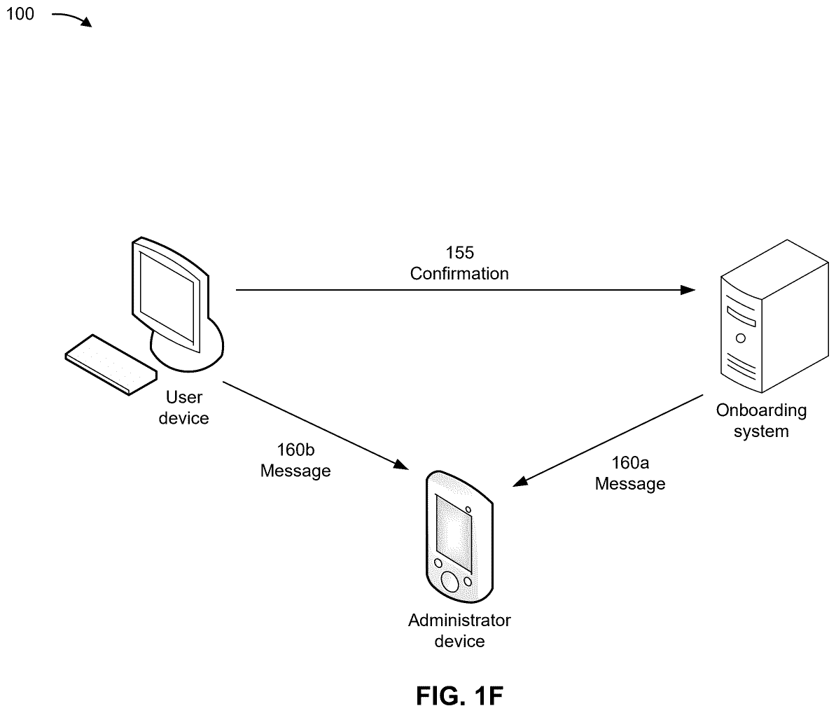

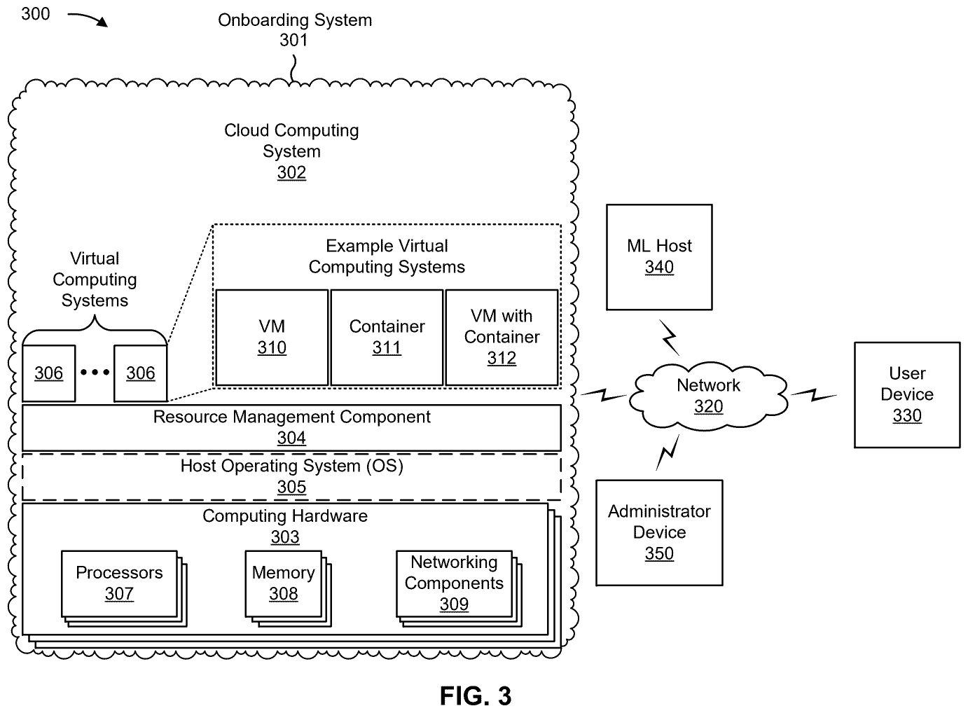

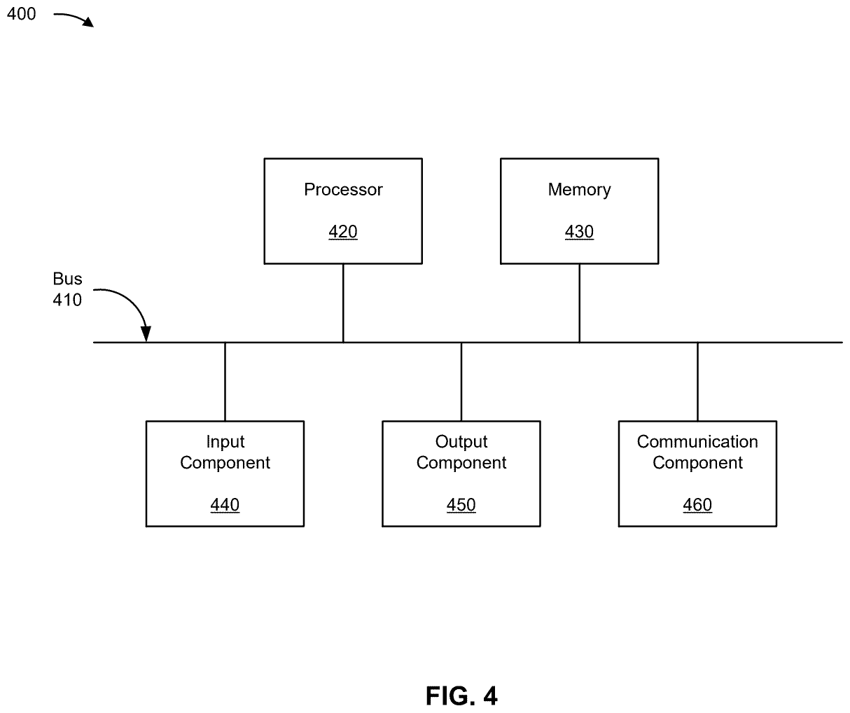

FIGS. 1A-1F are diagrams of an example 100 associated with a chatbot for an onboarding process. As shown in FIGS. 1A-1F, example 100 includes a user device, an onboarding system, a machine learning (ML) model (e.g., provided by an ML host), and an administrator device. These devices are described in more detail in connection with FIGS. 3 and 4.

In some implementations, as part of the onboarding process, the onboarding system may transmit, and the user device may receive, an indication of an assignment. The assignment may include a training module (e.g., a practice assignment or a text assessment, among other examples) or a work assignment, among other examples. In some implementations, the onboarding system may select the assignment based on a list of training modules. For example, the onboarding system may assign training modules on the list to a user of the user device in an ordered sequence. In some implementations, the onboarding system may select the assignment based on a skill matrix associated with the user. For example, the onboarding system may evaluate the user (e.g., using an assessment and/or previously completed training modules, among other examples) to calculate the skill matrix, and the onboarding system may use the skill matrix to select the assignment. In one example, for training purposes, the onboarding system may select the assignment because the assignment is associated with a skill in which the user is ranked poorly (e.g., failing to satisfy a competency threshold) or is not ranked at all (e.g., due to lack of assessments and/or training modules in the skill). In another example, for efficiency purposes, the onboarding system may select the assignment because the assignment is associated with a skill in which the user is ranked highly (e.g., satisfying the competency threshold).

The onboarding system may indicate the assignment in an email message, a push notification, or another type of message to the user device. The user device may use an output component of the user device to indicate the assignment to the user of the user device.

As shown in FIG. 1A and by reference number 105, the user device may transmit, and the onboarding system may receive, a first inquiry. The first inquiry may include a question related to a set of documentation. For example, the user may input (and the user device may transmit) a question about an application, a class, a function, a variable, and/or another aspect of software development associated with the set of documentation. Additionally, or alternatively, the first inquiry may include a question related to the assignment. For example, the user may input (and the user device may transmit) a question about how to complete a task within the assignment. In some implementations, the user may input the first inquiry using an input component of the user device. Accordingly, the user device may output a user interface (UI), such as a chat window, including the first inquiry.

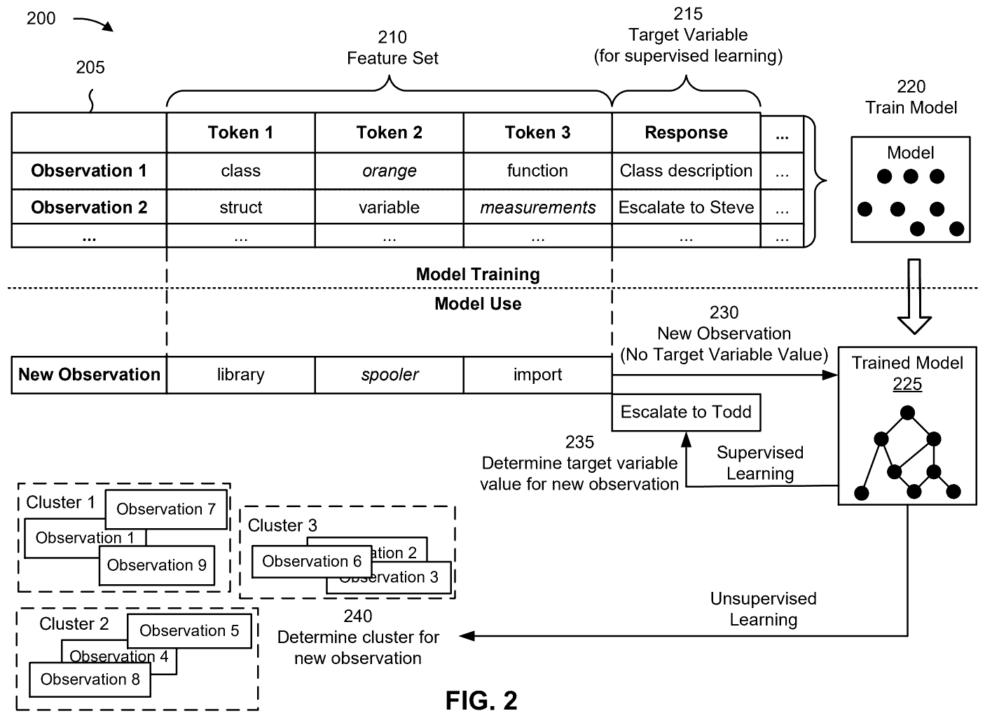

As shown in FIG. 1B and by reference number 110, the onboarding system may provide the first inquiry to the ML model. For example, the onboarding system may transmit, and the ML host may receive, a request including the first inquiry. The ML model may be trained (e.g., by the ML host and/or a device at least partially separate from the ML host) using the set of documentation and a labeled set of inquiries (e.g., for supervised learning). Additionally, or alternatively, the ML model may be trained using the set of documentation and an unlabeled set of security vulnerabilities (e.g., for deep learning). The ML model may be configured to determine responses to inquiries. In some implementations, the ML model may be trained and applied as described in connection with FIG. 2.

As shown by reference number 115, the onboarding system may receive a first response from the ML model (e.g., from the ML host). For example, the ML model may output a string variable encoding the first response.

As shown in FIG. 1C and by reference number 120, the onboarding system may transmit, and the user device may receive, the first response. The onboarding system may transmit, and the user device may receive, the first response in response to the first inquiry. In some implementations, the user device may output the first response to the user (e.g., using an output component of the user device). For example, the user device may output the first response in a UI, such as a chat window, including the first inquiry and the first response. By responding to the first inquiry in near-real-time, the onboarding system may function as a chatbot.

As shown by reference number 125a, the user device may transmit, and the onboarding system may receive, feedback associated with the first response. The feedback may include a rating (e.g., quantitative feedback, such as a score or a letter grade) and/or a text description (e.g., qualitative feedback). In some implementations, the onboarding system may transmit, and the user device may receive, a prompt. The user device may therefore output the prompt (e.g., using an output component of the user device) to the user (e.g., in the UI including the first inquiry and the first response, as described above). The user device may transmit, and the onboarding system may receive, the feedback in response to the prompt. In some implementations, the user may input the feedback using an input component of the user device. Accordingly, the user device may update a UI including the prompt to also include the feedback.

Additionally, or alternatively, as shown by reference number 125b, the onboarding system may detect a sentiment associated with input from the user device. Therefore, the feedback may include the sentiment. The sentiment may include whether the user is reacting positively or negatively to responses (e.g., the first response) from the onboarding system. For example, a happy or polite tone may be categorized as a positive reaction (and thus may represent positive feedback). On the other hand, an angry or rude tone may be categorized as a negative reaction (and thus may represent negative feedback).

In some implementations, the onboarding system may apply an additional ML model (e.g., provided by a same ML host as described in connection with FIG. 1B or by a different ML host) to determine the sentiment. Additionally, or alternatively, the onboarding system may apply a natural language processing (NLP) model to determine the sentiment.

The onboarding system may determine a feature (e.g., at least one feature), associated with the ML model, to eliminate based on the feedback. As used herein, a “feature” to eliminate may refer to a mathematical feature used in training and application of the ML model (e.g., as described in connection with FIG. 2) and/or to a set of possible responses that received negative feedback from the user (e.g., such that elimination of the set of possible responses results in different output from the ML model).

In some implementations, to determine the feature to eliminate, the onboarding system may identify, using the feedback, a portion of output from the ML model as unhelpful. For example, the feedback received (and/or the sentiment detected) from the user may be associated with the first response, and the onboarding system may identify the first response as unhelpful based on the feedback (and/or the sentiment). Therefore, the onboarding system may determine the feature based on the feature being mapped to the portion of the output. For example, the onboarding system may use a data structure that maps responses from the ML model to features (that is, to mathematical features used to train the ML model and/or to identifiers of possible responses from which the ML model selects).

As shown in FIG. 1D and by reference number 130, the onboarding system may transmit a command to update the ML model based on the feedback (and/or the sentiment). The command may be a command to remove the feature (e.g., determined as described above). Accordingly, the onboarding system may indicate (e.g., in a header and/or as an argument) the feature to eliminate. Alternatively, the onboarding system may indicate the portion of the output identified as unhelpful (e.g., as described above). Accordingly, the ML host may determine the feature to eliminate based on mapping the feature to the portion of the output. For example, the ML host may use a data structure that maps responses from the ML model to features (that is, to mathematical features used to train the ML model and/or to identifiers of possible responses from which the ML model selects).

By performing feature elimination, the onboarding system reduces overhead and bloat associated with the ML model. As a result, the onboarding system reduces power and processing resources that are consumed each time the ML model generates a response (e.g., in response to an inquiry from the onboarding system).

As shown by reference number 135, the ML model may be updated (e.g., by the ML host) by removing the feature. In some implementations, the onboarding system may transmit, and the user device may receive, an indication that the ML model has been updated based on the feedback. In some implementations, the user device may output the indication to the user (e.g., using an output component of the user device). For example, the user device may output the indication in a UI, such as a chat window, including the feedback.

As shown in FIG. 1E and by reference number 140, the user device may transmit, and the onboarding system may receive, a second inquiry. The second inquiry may include a question related to the set of documentation. For example, the user may input (and the user device may transmit) a question about an application, a class, a function, a variable, and/or another aspect of software development associated with the set of documentation. Additionally, or alternatively, the second inquiry may include a question related to the assignment (e.g., indicated to the user device as described above). For example, the user may input (and the user device may transmit) a question about how to complete a task within the assignment. In some implementations, the user may input the second inquiry using an input component of the user device. Accordingly, the user device may output a UI, such as a chat window, including the second inquiry.

As shown by reference number 145, the onboarding system may determine an escalation contact. The onboarding system may select the escalation contact from a plurality of possible escalation contacts. For example, the onboarding system may map a portion of the set of documentation (e.g., determined to be relevant to the second inquiry) to the escalation contact. Additionally, or alternatively, the onboarding system may determine the escalation contact based on content of the second inquiry. For example, the onboarding system may map keywords of the second inquiry to a documentation file (e.g., at least one documentation file). Accordingly, the onboarding system may determine the escalation contact as an administrator who authored (or is at least responsible for) the documentation file.

In some implementations, the onboarding system may provide the second inquiry to the ML model. For example, the onboarding system may transmit, and the ML host may receive, a request including the second inquiry. The ML model may be trained (e.g., by the ML host and/or a device at least partially separate from the ML host) using the set of documentation and a labeled set of possible escalation contacts (e.g., for supervised learning). Additionally, or alternatively, the ML model may be trained using the set of documentation and an unlabeled set of possible escalation contacts (e.g., for deep learning). The ML model may be configured to determine escalation contacts for inquiries. In some implementations, the ML model may be trained and applied as described in connection with FIG. 2. The onboarding system may receive an identifier of the escalation contact from the ML model (e.g., from the ML host). The identifier may include a username, a name, an email address, and/or a telephone number, among other examples.

As shown by reference number 150, the onboarding system may transmit, and the user device may receive, an indication of the escalation contact. The onboarding system may transmit, and the user device may receive, the indication in response to the second inquiry. In some implementations, the user device may output the indication to the user (e.g., using an output component of the user device). For example, the user device may output the indication in a UI, such as a chat window, including the second inquiry. By responding to the second inquiry in near-real-time, the onboarding system may function as a chatbot.

By selecting the escalation contact from the plurality of possible escalation contacts, the onboarding system performs targeted escalation. As a result, the onboarding system conserves power and processing resources that otherwise would have been consumed when the user would have been redirected to different experts from a generic escalation contact.

As shown in FIG. 1F, the user device may initiate communication with the escalation contact. For example, as shown by reference number 155, the user device may transmit, and the onboarding system may receive, a confirmation of the escalation contact. The user of the user device may provide input (e.g., using an input component of the user device) to trigger the user device to transmit the confirmation. In some implementations, the user device may output a UI (e.g., a chat window, as described above) that includes the indication of the escalation contact, and the user may interact with the UI to provide the input that triggers the user device to transmit the confirmation.

The confirmation may trigger a message to be sent to the escalation contact. For example, as shown by reference number 160a, the onboarding system may transmit, and the administrator device (associated with the escalation contact) may receive, the message. In some implementations, the message may include an email message, a text message, and/or a chat message, among other examples. The message may include the second inquiry from the user and request that the escalation contact provide help to the user.

Alternatively, as shown by reference number 160b, the user device may transmit, and the administrator device may receive, the message. For example, the indication of the escalation contact may include a hyperlink to an email address or a chat identifier associated with the escalation contact, and the user device may transmit an email message or a chat message, respectively, to the administrator device (e.g., associated with the hyperlink). In another example, the indication of the escalation contact may include a telephone number associated with the escalation contact, and the user device may transmit a text message to the administrator device (e.g., associated with the telephone number). The user device may transmit the second inquiry in the message (optionally with a request that the escalation contact provide help to the user).

In one example, the user device receives the indication of the escalation contact using a chat application executed by the user device. Accordingly, the indication of the escalation contact may be output to the user in a chat window of the chat application. Additionally, the user device may initiate a chat group including the escalation contact (e.g., in response to an interaction of the user with the indication of the escalation contact). Alternatively, the onboarding system may initiate the chat group (e.g., in response to the confirmation from the user device, as described above). The user device (or the onboarding system) may populate the chat group with the second inquiry (optionally with a request that the escalation contact provide help to the user).

In some implementations, the onboarding system may receive feedback associated with the escalation contact. For example, the onboarding system may receive the feedback from the user device, as described above in connection with reference number 125a. Accordingly, the onboarding system may perform feature elimination based on the feedback associated with the escalation contact, as described above in connection with FIG. 1D.

By using techniques as described in connection with FIGS. 1A-1F, the onboarding system may perform feature elimination on the ML model. As a result, the ML model has less overhead and bloat, which conserves power and processing resources each time the ML model generates a response to an inquiry. Additionally, the onboarding system may perform targeted escalation. For example, the onboarding system may identify the escalation contact based on content of the second inquiry. As a result, power and processing resources are conserved because the user is not redirected to different experts from a generic escalation contact.

As indicated above, FIGS. 1A-1F are provided as an example. Other examples may differ from what is described with regard to FIGS. 1A-1F.

FIG. 2 is a diagram illustrating an example 200 of training and using a machine learning model in connection with chatbots for onboarding processes. The machine learning model training and usage described herein may be performed using a machine learning system. The machine learning system may include or may be included in a computing device, a server, a cloud computing environment, or the like, such as an onboarding system, as described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from user devices and/or administrator devices, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from an onboarding system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a first token (e.g., a first keyword extracted from an inquiry), a second feature of a second token (e.g., a second keyword extracted from the inquiry), a third feature of a third token (e.g., a third keyword extracted from the inquiry), and so on. As shown, for a first observation, the first feature may have a value of “class,” the second feature may have a value of “orange,” the third feature may have a value of “function,” and so on. These features and feature values are provided as examples, and may differ in other examples. For example, the feature set may include one or more of the following features: non-tokenized keywords from an inquiry, phrases from an inquiry (e.g., whether tokenized or not), punctuation marks from an inquiry (e.g., whether tokenized or not), and/or keywords, phrases, and/or punctuation marks from previous inquiries, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a response, which has a value of a class description (e.g., for the class orange) for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on previous inquiries. For example, the training data may include exemplary responses in association with the previous inquiries. The exemplary responses may be input by an administrator and/or generated by a previous machine learning model.

As shown by reference number 230, the machine learning system may apply the trained machine learning model 225 to a new observation, such as by receiving a new observation and inputting the new observation to the trained machine learning model 225. As shown, the new observation may include a first feature of “struct,” a second feature of “variable,” a third feature of “measurements,” and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of escalate to Todd for the target variable of response for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, contact information associated with Todd. The first automated action may include, for example, sending a communication to Todd.

As another example, if the machine learning system were to predict a value of a variable description (e.g., for the class measurements) for the target variable of response, then the machine learning system may provide a second (e.g., different) recommendation (e.g., a portion of the set of documentation including the variable description) and/or may perform or cause performance of a second (e.g., different) automated action (e.g., outputting the variable description).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., inquiries to escalate), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., inquiries to answer), then the machine learning system may provide a second (e.g., different) recommendation (e.g., a portion of the set of documentation to output) and/or may perform or cause performance of a second (e.g., different) automated action, such as outputting a description from the set of documentation.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include quantitative feedback associated with responses (e.g., numerical scores and/or letter grades, among other examples) and/or qualitative feedback associated with responses (e.g., narrative feedback and/or tone measurement, among other examples).

In this way, the machine learning system may apply a rigorous and automated process to responding to inquiries and escalating to administrators. For example, the machine learning system may identify a particular administrator to contact. As a result, power and processing resources are conserved because a user is not redirected to different experts from a generic escalation contact. Additionally, as described in connection with FIG. 1D, the machine learning system may perform feature elimination, which conserves power and processing resources each time the machine learning system responds to an inquiry.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an onboarding system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an ML host 340, and/or an administrator device 350. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the onboarding system 301 may include one or more elements 303-312 of the cloud computing system 302, may execute within the cloud computing system 302, and/or may be hosted within the cloud computing system 302, in some implementations, the onboarding system 301 may not be cloud-based (e.g., may be implemented outside of a cloud computing system) or may be partially cloud-based. For example, the onboarding system 301 may include one or more devices that are not part of the cloud computing system 302, such as device 400 of FIG. 4, which may include a standalone server or another type of computing device. The onboarding system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with inquiries, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The ML host 340 may include one or more devices capable of receiving, generating, storing, processing, and/or providing information associated with machine learning models, as described elsewhere herein. The ML host 340 may include a communication device and/or a computing device. For example, the ML host 340 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 340 may communicate with one or more other devices of environment 300, as described elsewhere herein.

The administrator device 350 may include one or more devices capable of receiving, generating, storing, processing, and/or providing information associated with escalations, as described elsewhere herein. The administrator device 350 may include a communication device and/or a computing device. For example, the administrator device 350 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 350 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with chatbots for onboarding processes. The device 400 may correspond to a user device 330, an ML host 340, and/or an administrator device 350. In some implementations, a user device 330, an ML host 340, and/or an administrator device 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

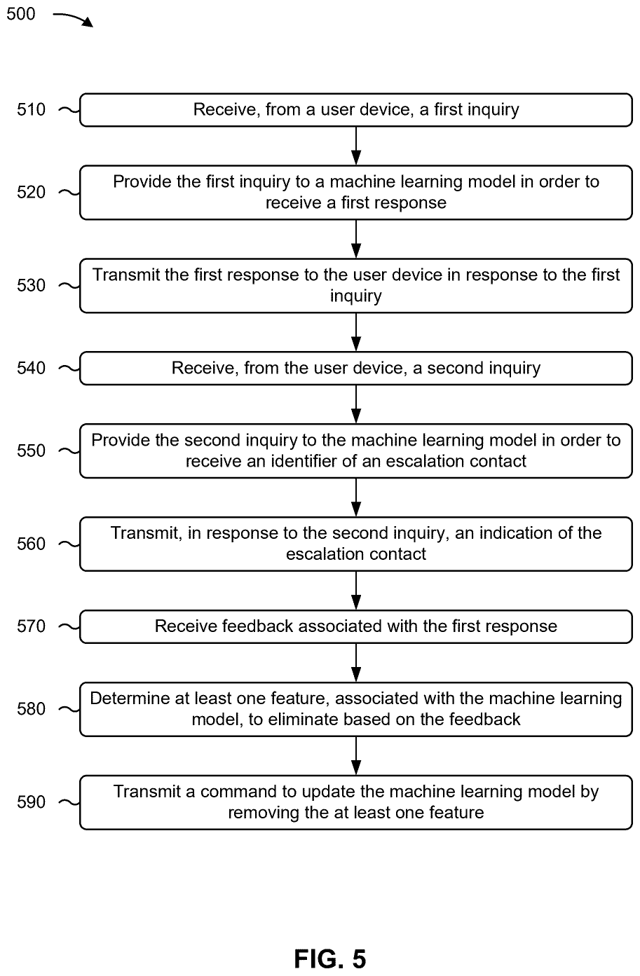

FIG. 5 is a flowchart of an example process 500 associated with providing a chatbot for an onboarding process. In some implementations, one or more process blocks of FIG. 5 may be performed by an onboarding system 301. In some implementations, one or more process blocks of FIG. 5 may be performed by another device or a group of devices separate from or including the onboarding system 301, such as a user device 330, an ML host 340, and/or an administrator device 350. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a first inquiry (block 510). For example, the onboarding system 301 (e.g., using processor 420, memory 430, input component 440, and/or communication component 460) may receive, from a user device, a first inquiry, as described above in connection with reference number 105 of FIG. 1A. As an example, the first inquiry may include a question related to a set of documentation (e.g., a question about an application, a class, a function, a variable, and/or another aspect of software development associated with the set of documentation). Additionally, or alternatively, the first inquiry may include a question related to an assignment from the onboarding system 301 (e.g., a question about how to complete a task within the assignment).

As further shown in FIG. 5, process 500 may include providing the first inquiry to a machine learning model in order to receive a first response (block 520). For example, the onboarding system 301 (e.g., using processor 420, memory 430, and/or communication component 460) may provide the first inquiry to a machine learning model in order to receive a first response, as described above in connection with reference numbers 110 and 115 of FIG. 1B. As an example, the onboarding system 301 may transmit a request including the first inquiry to an ML host (associated with the machine learning model), and the onboarding system 301 may receive the first response from the ML host. The machine learning model may be trained and applied as described in connection with FIG. 2.

As further shown in FIG. 5, process 500 may include transmitting the first response to the user device in response to the first inquiry (block 530). For example, the onboarding system 301 (e.g., using processor 420, memory 430, output component 450, and/or communication component 460) may transmit the first response to the user device in response to the first inquiry, as described above in connection with reference number 120 of FIG. 1C. As an example, the onboarding system 301 may output the first response to the first inquiry in near-real-time and thus may function as a chatbot.

As further shown in FIG. 5, process 500 may include receiving, from the user device, a second inquiry (block 540). For example, the onboarding system 301 (e.g., using processor 420, memory 430, input component 440, and/or communication component 460) may receive, from the user device, a second inquiry, as described above in connection with reference number 140 of FIG. 1E. As an example, the second inquiry may include a question related to a set of documentation (e.g., a question about an application, a class, a function, a variable, and/or another aspect of software development associated with the set of documentation). Additionally, or alternatively, the second inquiry may include a question related to an assignment from the onboarding system 301 (e.g., a question about how to complete a task within the assignment).

As further shown in FIG. 5, process 500 may include providing the second inquiry to the machine learning model in order to receive an identifier of an escalation contact (block 550). For example, the onboarding system 301 (e.g., using processor 420, memory 430, and/or communication component 460) may provide the second inquiry to the machine learning model in order to receive an identifier of an escalation contact, as described above in connection with reference number 145 of FIG. 1E. As an example, the onboarding system 301 may transmit a request including the second inquiry to an ML host (associated with the machine learning model), and the onboarding system 301 may receive the identifier of the escalation contact from the ML host. The machine learning model may be trained and applied as described in connection with FIG. 2.

As further shown in FIG. 5, process 500 may include transmitting, in response to the second inquiry, an indication of the escalation contact (block 560). For example, the onboarding system 301 (e.g., using processor 420, memory 430, output component 450, and/or communication component 460) may transmit, in response to the second inquiry, an indication of the escalation contact, as described above in connection with reference number 150 of FIG. 1E. As an example, the onboarding system 301 may output the indication of the escalation contact in response to the second inquiry in near-real-time and thus may function as a chatbot.

As further shown in FIG. 5, process 500 may include receiving feedback associated with the first response (block 570). For example, the onboarding system 301 (e.g., using processor 420, memory 430, input component 440, and/or communication component 460) may receive feedback associated with the first response, as described above in connection with reference number 125a and/or reference number 125b of FIG. 1C. As an example, the onboarding system 301 may receive the feedback from the user device. The feedback may include a rating (e.g., quantitative feedback, such as a score or a letter grade) and/or a text description (e.g., qualitative feedback). Additionally, or alternatively, the onboarding system 301 may detect a sentiment associated with input from the user device. Therefore, the feedback may include the sentiment.

As further shown in FIG. 5, process 500 may include determining at least one feature, associated with the machine learning model, to eliminate based on the feedback (block 580). For example, the onboarding system 301 (e.g., using processor 420 and/or memory 430) may determine at least one feature, associated with the machine learning model, to eliminate based on the feedback, as described above in connection with FIG. 1D. As an example, the onboarding system 301 may identify, using the feedback, a portion of output from the machine learning model as unhelpful. For example, the onboarding system 301 may identify the first response as unhelpful based on the feedback; therefore, the onboarding system 301 may determine the at least one feature based on the at least one feature being mapped to the first response. The onboarding system 301 may use a data structure that maps responses from the machine learning model to features (that is, to mathematical features used to train the machine learning model and/or to identifiers of possible responses from which the machine learning model selects).

As further shown in FIG. 5, process 500 may include transmitting a command to update the machine learning model by removing the at least one feature (block 590). For example, the onboarding system 301 (e.g., using processor 420, memory 430, and/or communication component 460) may transmit a command to update the machine learning model by removing the at least one feature, as described above in connection with reference number 130 of FIG. 1D. As an example, the onboarding system 301 may indicate (e.g., in a header and/or as an argument) the at least one feature to eliminate. Alternatively, the onboarding system 301 may indicate the portion of the output identified as unhelpful (e.g., the first response). Accordingly, the ML host (associated with the machine learning model) may determine the at least one feature to eliminate based on the portion of the output indicated in the command.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

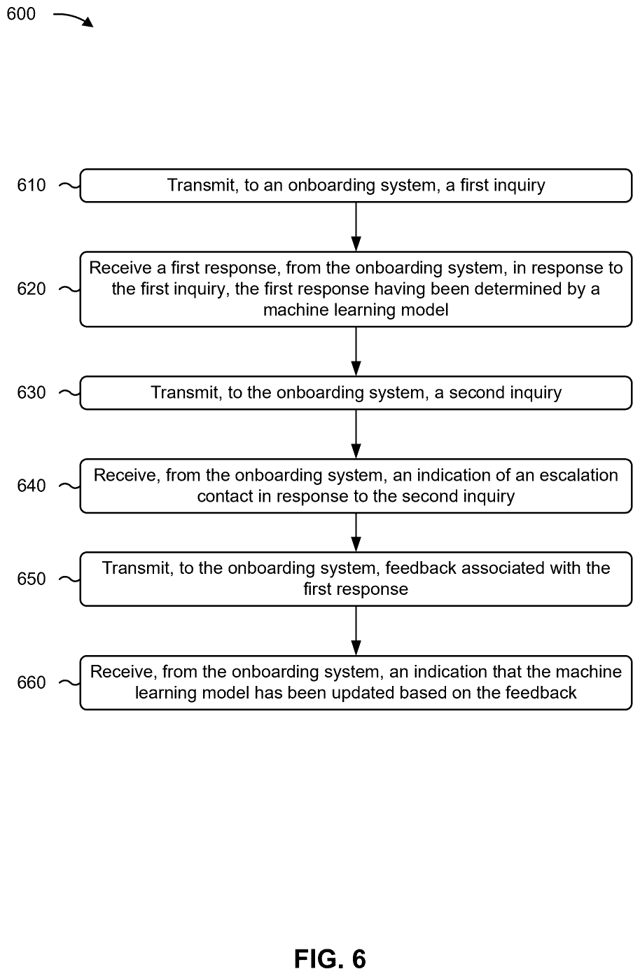

FIG. 6 is a flowchart of an example process 600 associated with using a chatbot for an onboarding process. In some implementations, one or more process blocks of FIG. 6 may be performed by a user device 330. In some implementations, one or more process blocks of FIG. 6 may be performed by another device or a group of devices separate from or including the user device 330, such as an onboarding system 301, an ML host 340, and/or an administrator device 350. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to an onboarding system, a first inquiry (block 610). For example, the user device 330 (e.g., using processor 420, memory 430, and/or communication component 460) may transmit, to an onboarding system, a first inquiry, as described above in connection with reference number 105 of FIG. 1A. As an example, a user may input, and the user device 330 may transmit, a question about an application, a class, a function, a variable, and/or another aspect of software development associated with a set of documentation. Additionally, or alternatively, the user may input, and the user device 330 may transmit, a question about how to complete a task within an assignment. In some implementations, the user may input the first inquiry using an input component of the user device 330. Accordingly, the user device 330 may output a UI, such as a chat window, including the first inquiry.

As further shown in FIG. 6, process 600 may include receiving a first response, from the onboarding system, in response to the first inquiry, the first response having been determined by a machine learning model (block 620). For example, the user device 330 (e.g., using processor 420, memory 430, and/or communication component 460) may receive a first response, from the onboarding system, in response to the first inquiry, the first response having been determined by a machine learning model, as described above in connection with reference number 120 of FIG. 1C. As an example, the user device 330 may output the first response to the user (e.g., using an output component of the user device 330). For example, the user device 330 may output the first response in a UI, such as a chat window, including the first inquiry and the first response.

As further shown in FIG. 6, process 600 may include transmitting, to the onboarding system, a second inquiry (block 630). For example, the user device 330 (e.g., using processor 420, memory 430, and/or communication component 460) may transmit, to the onboarding system, a second inquiry, as described above in connection with reference number 140 of FIG. 1E. As an example, the user may input, and the user device 330 may transmit, a question about an application, a class, a function, a variable, and/or another aspect of software development associated with a set of documentation. Additionally, or alternatively, the user may input, and the user device 330 may transmit, a question about how to complete a task within an assignment. In some implementations, the user may input the second inquiry using an input component of the user device 330. Accordingly, the user device 330 may output a UI, such as a chat window, including the second inquiry.

As further shown in FIG. 6, process 600 may include receiving, from the onboarding system, an indication of an escalation contact in response to the second inquiry (block 640). For example, the user device 330 (e.g., using processor 420, memory 430, and/or communication component 460) may receive, from the onboarding system, an indication of an escalation contact in response to the second inquiry, as described above in connection with reference number 150 of FIG. 1E. As an example, the user device 330 may output the indication to the user (e.g., using an output component of the user device 330). For example, the user device 330 may output the indication in a UI, such as a chat window, including the second inquiry.

As further shown in FIG. 6, process 600 may include transmitting, to the onboarding system, feedback associated with the first response (block 650). For example, the user device 330 (e.g., using processor 420, memory 430, and/or communication component 460) may transmit, to the onboarding system, feedback associated with the first response, as described above in connection with reference number 125a of FIG. 1C. As an example, the feedback may include a rating (e.g., quantitative feedback, such as a score or a letter grade) and/or a text description (e.g., qualitative feedback). In some implementations, the user device 330 may receive a prompt from the onboarding system, and the user device 330 may output the prompt (e.g., using an output component of the user device 330) to the user. The user device 330 may transmit the feedback to the onboarding system in response to the prompt. In some implementations, the user may input the feedback using an input component of the user device 330. Accordingly, the user device 330 may update a UI including the prompt to also include the feedback.

As further shown in FIG. 6, process 600 may include receiving, from the onboarding system, an indication that the machine learning model has been updated based on the feedback (block 660). For example, the user device 330 (e.g., using processor 420, memory 430, and/or communication component 460) may receive, from the onboarding system, an indication that the machine learning model has been updated based on the feedback, as described above in connection with FIG. 1D. As an example, the user device 330 may output the indication to the user (e.g., using an output component of the user device 330). For example, the user device 330 may output the indication in a UI, such as a chat window, including the feedback.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1F and/or FIG. 2. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing a chatbot for an onboarding process, the system comprising:
one or more memories; and
one or more processors, communicatively coupled to the one or more memories, configured to:
receive, from a user device, a first inquiry;
provide the first inquiry to a machine learning model in order to receive a first response;
transmit the first response to the user device in response to the first inquiry;
receive, from the user device, a second inquiry;
provide the second inquiry to the machine learning model in order to receive an identifier of an escalation contact;
transmit, in response to the second inquiry, an indication of the escalation contact;
receive feedback associated with the first response;
determine at least one feature, associated with the machine learning model, to eliminate based on the feedback; and
transmit a command to update the machine learning model by removing the at least one feature.

2. The system of claim 1, wherein the machine learning model is trained on a set of documentation associated with the onboarding process.

3. The system of claim 2, wherein the escalation contact is associated with a portion of the set of documentation that was determined to be relevant to the second inquiry.

4. The system of claim 1, wherein the escalation contact is selected from a plurality of possible escalation contacts.

5. The system of claim 1, wherein the one or more processors, to determine the at least one feature, are configured to:
identify, using the feedback, a portion of output from the machine learning model as unhelpful; and
determine the at least one feature based on the at least one feature being mapped to the portion of the output.

6. The system of claim 1, wherein the one or more processors, to receive the feedback, are configured to:
transmit, to the user device, a prompt; and
receive, from the user device, the feedback in response to the prompt.

7. The system of claim 1, wherein the one or more processors, to receive the feedback, are configured to:
detect a sentiment associated with input from the user device,
wherein the feedback comprises the sentiment.

8. A method of using a chatbot for an onboarding process, comprising:
transmitting, from a user device and to an onboarding system, a first inquiry;
receiving a first response, from the onboarding system and at the user device, in response to the first inquiry, wherein the first response was determined by a machine learning model;
transmitting, from the user device and to the onboarding system, a second inquiry;
receiving, from the onboarding system and at the user device, an indication of an escalation contact in response to the second inquiry;
transmitting, from the user device and to the onboarding system, feedback associated with the first response; and
receiving, from the onboarding system and at the user device, an indication that the machine learning model has been updated based on the feedback.

9. The method of claim 8, further comprising:
transmitting, from the user device and to the onboarding system, a confirmation of the escalation contact,
wherein the confirmation triggers a message to be sent to the escalation contact.

10. The method of claim 8, wherein the indication of the escalation contact comprises a hyperlink to an email address or a chat identifier associated with the escalation contact.

11. The method of claim 8, wherein the indication of the escalation contact is received using a chat application executed by the user device, and the method further comprises:
initiating a chat group including the escalation contact.

12. The method of claim 8, wherein the feedback comprises a rating.

13. The method of claim 8, wherein the feedback comprises a text description.

14. The method of claim 8, further comprising:
receiving, from the onboarding system and at the user device, an indication of an assignment.

15. A non-transitory computer-readable medium storing a set of instructions for providing a chatbot for an onboarding process, the set of instructions comprising:
one or more instructions that, when executed by one or more processors of a device, cause the device to:
receive, from a user device, a first inquiry;
provide the first inquiry to a machine learning model in order to receive a first response;
transmit the first response to the user device in response to the first inquiry;
receive, from the user device, a second inquiry;
determine an escalation contact, selected from a plurality of possible escalation contacts, based on content of the second inquiry;
transmit, in response to the second inquiry, an indication of the escalation contact;
detect a sentiment associated with input from the user device;
determine at least one feature, associated with the machine learning model, to eliminate based on the sentiment; and
transmit a command to update the machine learning model by removing the at least one feature.

16. The non-transitory computer-readable medium of claim 15, wherein the one or more instructions, that cause the device to transmit the command, cause the device to:
transmit the command to a machine learning host associated with the machine learning model.

17. The non-transitory computer-readable medium of claim 15, wherein the one or more instructions, that cause the device to determine the at least one feature, cause the device to:
identify, using the sentiment, a portion of output from the machine learning model as unhelpful; and
determine the at least one feature based on the at least one feature being mapped to the portion of the output.

18. The non-transitory computer-readable medium of claim 15, wherein the one or more instructions, that cause the device to provide the first inquiry to the machine learning model, cause the device to:
transmit a request including the first inquiry to a machine learning host associated with the machine learning model; and
receive the first response from the machine learning host in response to the request.

19. The non-transitory computer-readable medium of claim 15, wherein the one or more instructions, that cause the device to detect the sentiment, cause the device to:
provide the input from the user device to an additional machine learning model in order to receive an indication of the sentiment.

20. The non-transitory computer-readable medium of claim 15, wherein the one or more instructions, that cause the device to determine the escalation contact, cause the device to:
map the second inquiry to at least one documentation file; and
map the at least one documentation file to the escalation contact.
